(19) United States
(12) Patent Application Publication
(10) Pub. No.: US 2016/0279550 A1
(43) Pub. Date: Sep. 29, 2016

(54) FILTER MATERIAL, FILTER ELEMENT, AND A METHOD AND A DEVICE FOR PRODUCING A FILTER MATERIAL

(71) Applicant: MAHLE INTERNATIONAL GMBH, Stuttgart (DE)

(72) Inventors: Sushil Agrahari, Kanpur (IN); Rajeev Kapoor, New Delhi (IN); Mahesh Kumar, Gurgaon (IN); Puneet Singla, Faridabad (IN)

(21) Appl. No.: 14/915,113

(22) PCT Filed: Aug. 28, 2014
(86) PCT No.: PCT/EP2014/068215

§ 371 Date: Feb. 26, 2016

(30) Foreign Application Priority Data
Aug. 29, 2013 (IN) 2553/DEL/2013
Oct. 21, 2013 (DE) 10 2013 221 340.9

(51) Int. Cl. B01D 39/18; B01D 46/00; B01D 46/52; B01D 39/16; B01D 29/01

(52) U.S. Cl. CPC B01D 39/18; B01D 39/163; B01D 29/016; B01D 46/521; B01D 46/0001; B01D 29/012; B01D 2239/025; B01D 2239/0681; B01D 2239/083; B01D 2239/10; B01D 2239/1233; B01D 2239/0464

(57) ABSTRACT

A multi-layered, web-shaped filter material for a filter element may include a fleece layer, a cellulose layer, and a nanofibre layer arranged between the fleece layer and the cellulose layer. The nanofibre layer may have, in a thickness direction, at least one of an increasing fibre thickness and an increasing fibre density. The cellulose layer may have an impregnation at least on a side facing the nanofibre layer.

### CROSS-REFERENCE TO RELATED APPLICATIONS

This application claims priority to India Patent Application No. 2553/DEL/2013, filed Aug. 29, 2013, German Patent Application No. 10 2013 221 340.9, filed Oct. 21, 2013, and International Patent Application No. PCT/EP2014/068215, filed Aug. 28, 2014, all of which are hereby incorporated by reference in their entirety.

### TECHNICAL FIELD

The present invention relates to a multi-layered, web-shaped filter material for filter elements for the filtration of gases and/or liquids. The invention additionally relates to a filter element which is produced by means of such a filter material. Finally, the present invention relates to a method and a device for producing such a filter material.

### BACKGROUND

Filtration tasks exist in many technical areas. Of particular importance within the scope of the present application are vehicle applications, i.e. filtration tasks on or in vehicles, such as for example in an air filter, a fuel filter, an oil filter.

In a filter or a filter device, filter elements are employed which each comprise at least one filter body. Here, the filter body is preferably produced from a web-shaped filter material, which for forming the filter body is folded or pleated. Multi-layered filter materials are known in principle for an efficient filtration and long service lives. For realising high degrees of separation for small and smallest contaminations, nanofilters are additionally known. In filtration there exists the general problem that with increasing degree of filtration a flow resistance of the filter material increases as well. If for example a particularly high degree of filtration is aimed at in particular in connection with a nanostructure, a very high flow resistance is generally obtained for the associated filter material. High flow resistances however are disadvantageous since on the one hand they mechanically load the filter element and on the other hand require an adapted periphery if applicable, such as for example increased rates of delivery of pumps and intensified sealing measures.

Filter materials are known for example from U.S. Pat. No. 5,993,501 A, DE 10 2007 027 299 B4, WO 2013/068436 A1 and EP 1 366 791 A1.

### SUMMARY

The present invention deals with the problem of stating an improved embodiment for a filter material or for a filter element or for a production method and for a production device, which is characterized in particular by a high degree of filtration with comparatively low flow resistance.

According to the invention, this problem is solved through the subjects of the independent claims. Advantageous embodiments are subject of the dependent claims.

The invention is based on the general idea of designing the filter material at least in three layers and to equip said filter material with at least one fleece layer, a cellulose layer and a nanofibre layer arranged between the fleece layer and the cellulose layer. It is proposed, furthermore to equip the nanofibre layer in a thickness direction of the filter material with an increasing fibre thickness and/or with an increasing fibre density. It has been shown that such a configuration results in that with a high degree of filtration a comparatively low flow resistance can be realised. This is explained by the fact that smaller particles are separated only in the depth of the nanofibre layer and not already on the outside, which applies to larger contaminations. In contrast with a conventional nanofibre structure, in which the fibre thickness and the fibre density are continuous in the thickness direction of the fibre material, the contaminations thus are not only deposited on the nanofibre layer on the outside but also in its interior, so that it clogs less severely and less rapidly.

According to an advantageous further development, the fibre thickness and/or the fibre density in the thickness direction of the filter material can increase continuously, preferentially evenly or in steps. A two-step configuration is conceivable in principle here. However, more than two steps are preferably provided or a stepless variation of the fibre thickness and/or fibre density.

Practically, the fibre thickness and/or the fibre density can increase from the fleece layer to the cellulose layer. This can then also be a preferred flow direction of the filter material here.

For example, the fibre thickness within the nanofibre layer can vary in a range from 100 nm to 800 nm.

According to another particularly advantageous embodiment, the nanofibre layer can be formed through a coating of the fleece layer with nanofibres. In this manner, the nanofibre layer is directly formed on the fleece layer. This produces, in particular, a fixed connection between the nanofibre layer and the fleece layer. Additionally or alternatively it can be provided to glue the cellulose layer onto the nanofibre layer by means of an adhesive. In this way, a fixed connection is also realised between the nanofibre layer and the cellulose layer. Preferred is a configuration, in which the nanofibre layer is formed through a coating of the fleece layer with nanofibres and the cellulose layer is glued onto the nanofibre layer by means of an adhesive. Because of this, all three layers are connected in a fixed manner. It has been shown that because of this, shear flows, which are orientated in the plane of the filter material, are avoided, so that substantially only a flow of the filter material transversely to its plane, i.e. in the thickness direction of the filter material is present, which substantially reduces the flow resistance. According to a preferred embodiment, the cellulose layer can be provided with an impregnation at least on a side facing the nanofibre layer. Through the impregnation, a clogging of pores of the cellulose layer in particular can be impeded or prevented.

According to an advantageous further development, the impregnation can be matched to the adhesive and prevent or at least impede the adhesive entering the cellulose layer.

In another advantageous embodiment, the adhesive can be produced on a water base. Additionally or alternatively, the impregnation can be produced on a silicone base or consist of silicone. Water-based adhesive is particularly environmentally compatible and simplifies recycling the filter material. An impregnation on silicone base or of silicone is characterized by a particularly high hydrophobization of the cellulose.

A filter element according to the invention, which is suitable for filtering gases and/or liquids, in particular in vehicle applications, comprises at least one filter body which during the operation of the filter element is subjected to a through-flow of gas and/or liquid, wherein the respective filter body comprises a filter material of the type described above.

To enlarge the available filtration area, the filter material can be pleated, i.e. folded.

Particularly practically, the filter element can be a ring filter element with a ring-shaped filter body or a plate filter element with plate-shaped filter body. Such filter elements can be produced particularly easily in large quantities, as a result of which they are particularly suitable for vehicle applications.

A method according to the invention for producing a multi-layered web-shaped filter material, in particular of the type described above is characterized in that a web-shaped fleece layer is coated on the one side with nanofibres in order to generate a nanofibre layer directly on the fleece layer. Furthermore, a web-shaped cellulose layer is glued to this nanofibre layer. Furthermore, the coating of the fleece layer with nanofibres takes place in such a manner that the resulting nanofibre layer in a thickness direction of the filter material has an increasing fibre thickness and/or an increasing fibre density. As explained, this produces a reduced flow resistance with high filtration effect.

According to an advantageous embodiment, the nanofibres can be electrostatically applied onto the fleece layer in a coating station, wherein in a fibre dispensing device of the coating station there is a spacing between the liquid fibre material and the fleece layer. This means that the fleece layer does not directly come into contact with the liquid fibre material, in particular, an immersing of the fleece layer in the liquid fibre material is avoided. The fleece layer is guided past the liquid fibre material spaced from said liquid fibre material. The transfer of fibre material to the fleece layer is carried out by means of ion currents, which are generated through electrostatic voltages. In order for individual molecules of the fibre material to be better able to detach from the fibre material, a line-shaped or dot-shaped dispensing surface is provided within the fibre dispensing device of the coating station, from which the individual molecules can separate more easily. Such a line-shaped dispensing surface can for example be generated with the help of a roll, which on its bottom side dips into the liquid fibre material and which on its top side forms this line-shaped dispensing surface, which faces the fleece layer. However, preferred is an embodiment in which a kind of conveyor belt is used, which in a conveying direction of the conveyor belt comprises a plurality of web-shaped or rod-shaped dispensing elements, wherein each individual dispensing element defines a line-shaped or respectively dot-shaped dispensing surface or respectively dispensing zone. These dispensing elements are arranged behind one another in the conveying direction of the conveyor belt and are spaced from one another in the conveying direction. On its bottom side, the conveyor belt dips into the liquid fibre material at least in the region of the dispensing elements. On the top side of the conveyor belt, the dispensing elements are then facing the fleece layer, so that on each dispensing element filter material can be dispensed via the respective, line-shaped or respectively dot-shaped dispensing zone.

According to an advantageous further development, the spacing between fleece layer and fibre material or between fleece layer and dispensing surface can increase or decrease in the movement direction of the fleece layer. It has been shown that the spacing between fleece layer and the liquid fibre material or the dispensing zone is decisive for the fibre thickness or fibre density that can be achieved.

In another embodiment, the fleece layer can be moved past a horizontal and flat surface of the filter material with an inclination, as a result of which a continuous change of the spacing between the fleece layer and the fibre material or the respective dispensing surface can be realised. For adjusting the spacings, provision can be optionally made that an inclination of the fleece layer with respect to a horizontal plane is able to be adjusted.

In another embodiment, a plurality of dispensing devices can be provided one after the other in the movement direction of the fleece layer, in which there are different spacings between the fibre material or the respective dispensing zone and the fleece layer. Here it is also conceivable to configure the individual fibre dispensing devices each in the manner of a conveyor belt of the type described above. The individual fibre dispensing devices can be optionally vertical adjustable here, in order to be able to adjust the spacings.

In another advantageous embodiment it can be provided to apply an adhesive onto the cellulose layer and to bring the cellulose layer together with the fleece layer in such a manner that the adhesive connects the cellulose layer to the nanofibre layer.

According to an advantageous further development it can be provided that the web-shaped cellulose layer is provided with an impregnation at least on one side prior to applying the adhesive, wherein the adhesive is then subsequently applied onto the impregnated side of the cellulose layer.

The fleece layer can also be called “non-woven” or “blow-melt”.

A device according to the invention for producing a filter material, in particular of the type described above, comprises at least one fibre dispensing device, which has a conveyor belt with at least two rolls and a tub which is able to be filled with liquid fibre material, into which the conveyor belt dips at least on a bottom side, at least two deflection rollers for guiding a fleece layer above the fibre dispensing device and spaced apart from a top side of the conveyor belt and an ionising device for generating different electrical potentials on the fleece layer and on the fibre dispensing device, such that in the operation of the device, liquid fibre material is transported electrostatically from the conveyor belt to the fleece layer. It has been found that with such a device a nanofibre layer can be applied particularly simply and with reproducible parameters such as density and thickness onto the fleece layer.

According to an advantageous embodiment, the device can be configured so that a spacing between the fleece layer and the respective top side of the conveyor belt varies in the direction of movement of the fleece layer. Hereby, a graduated coating, i.e. a coating with a density varying in the thickness direction, can be applied onto the fleece layer.

Advantageously, said spacing can be adjusted e.g. in that at least one of the deflection rollers is arranged so as to be vertically adjustable. Additionally or alternatively, provision can be made that at least one such fibre dispensing device is arranged so as to be vertically adjustable.

A varying spacing can also be realized in that the rolls are arranged so that the top side of the conveyor belt runs in an inclined manner with respect to a horizontal plane. For this, the rolls can have different diameters and/or can be arranged at different levels, so that they dip into the tub at different depths.

Further important features and advantages of the invention are obtained from the subclaims, from the drawings and from the associated Figure description by means of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference characters relate to same or similar or functionally same components.

### BRIEF DESCRIPTION OF THE DRAWINGS

The drawings show, in each case schematically:

FIG. 1 a greatly simplified sectional view of a filter material,

FIG. 2 a greatly simplified schematic diagram of a device for producing filter material,

FIG. 3 a greatly simplified schematic diagram of a coating station,

FIGS. 4 to 6 each illustrate a schematic diagram of a coating station as in FIG. 3, however with views showing a different example of the coating station.

### DETAILED DESCRIPTION

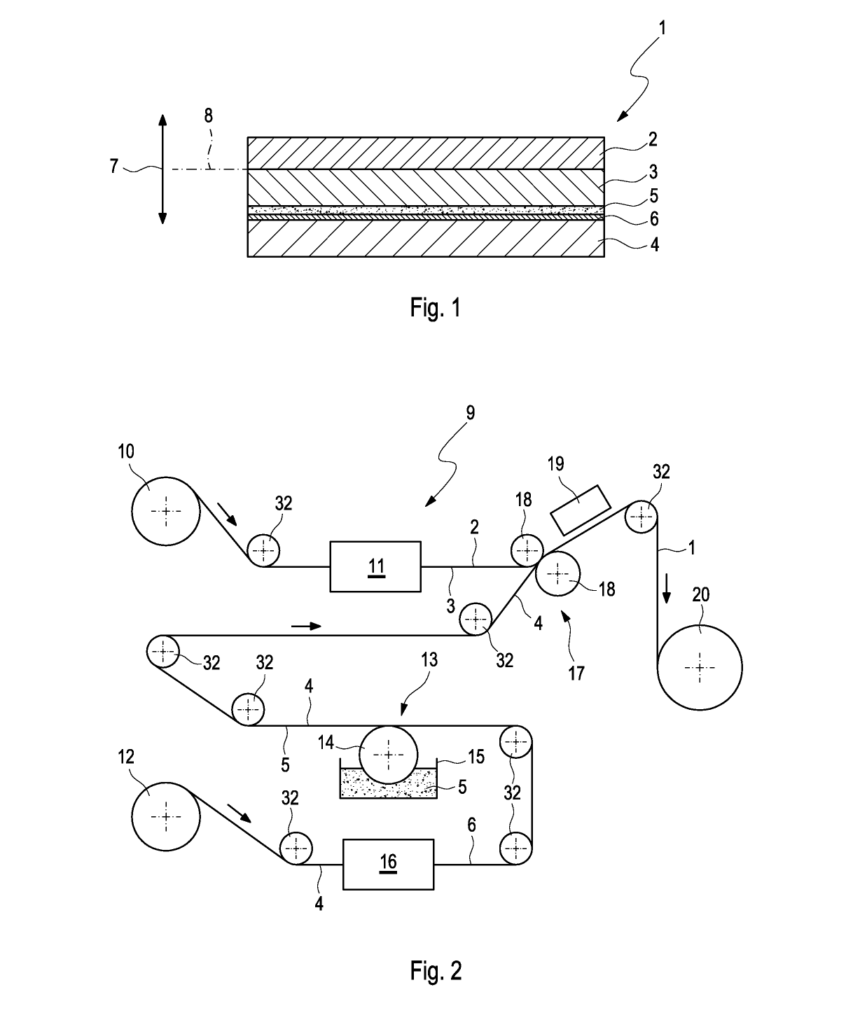

According to FIG. 1, a multi-layered, web-shaped filter material 1, which is suitable for producing filter elements and for filtering gases and/or liquids, comprises an at least three-layered structure, so that the filter material 1 comprises a fleece layer 2, a nanofibre layer 3 and a cellulose layer 4. Here, the nanofibre layer 3 is arranged between the fleece layer 2 and the cellulose layer 4. The nanofibre layer 3 is preferably formed in that a coating of nanofibres is applied onto the fleece layer 2. Because of this, the nanofibre layer 3 is connected to the fleece layer 2 in a fixed manner. The cellulose layer 4 is glued onto the nanofibre layer 3 by means of an adhesive 5, i.e. likewise connected to the nanofibre layer 3 in a fixed manner. Practically, the cellulose layer 4 is provided with an impregnation 6 on a side facing the nanofibre layer 3. Thus, the gluing of the nanofibre layer 3 to the cellulose layer 4 by means of the adhesive 5 takes place indirectly, namely by way of the impregnation 6.

The impregnation 6 is matched to the adhesive 5 in such a manner that the impregnation 6 prevents or at least impedes an entering of the non-dried or non-cured adhesive 5 which is usually applied in liquid form penetrating the cellulose layer 4. For example, the adhesive 5 is produced on a water base so that it solidifies in particular through drying. The impregnation 6 is then practically produced on a silicone base or directly formed through silicone.

In a thickness direction 7 indicated by an arrow, which extends transversely to a web plane 8, in which the filter material 1 lies, the nanofibre layer 3 has an increasing fibre thickness and an increasing fibre density. As a rule, an increasing fibre thickness simultaneously leads to an increasing fibre density, which on its part is accompanied by a reduction of the pore size of the nanofibre layer 3 and thus by an increased filtration effect. An embodiment, in which the fibre thickness increases while the fibre density substantially remains constant or in which the fibre density increases while the fibre thickness substantially remains constant is also conceivable.

The fibre thickness and/or the fibre density can increase in the thickness direction 7 of the filter material 1 steplessly or in steps. With a stepless increase, an even or linear increase can be preferred. With a step increase, two or more steps are conceivable.

Preferentially, the fibre thickness or the fibre density increases from the fleece layer 2 in the direction of the cellulose layer 4. I.e., in this case, against the thickness direction 7 according to FIG. 1. A preferred flow direction of the filter material 1 then corresponds to the direction in which the fibre thickness or the fibre density also increases. Accordingly, a preferred flow direction of the filter material 1 is directed against the thickness direction 7.

With the help of the filter material 1 shown here, a filter element which is not shown here can be produced, which serves for the filtering of gases and/or liquids and serves for filtering out solid contaminations. To this end, the respective filter element comprises at least one filter body which is produced with the help of such a filter material 1. During the operation of the filter element, this filter body is subjected to the throughflow of the fluid to be cleaned. Practically, the filter material 1 in the filter body is pleated, i.e. folded zig-zag-shaped. In preferred embodiments, the filter element is a ring filter element which is characterized by a ring-shaped filter body, or a plate filter element, which is characterized by a plate-shaped, in particular flat filter body.

In the following, a method for producing a multi-layered, web-shaped filter material 1 is described by means of FIGS. 2 to 6, wherein an associated device 9 is reproduced in a greatly simplified manner.

Within the scope of the production method, a web-shaped fleece layer 2 is coated on one side with nanofibres, as a result of which a nanofibre layer 3 is generated directly on the fleece layer 2. To this end, the fleece layer 2 is reeled from a fleece layer reel 10, which quasi continuously provides the fleece layer 2. In a coating station 11, the one-sided coating of the fleece layer 2 with nanofibres takes place in order to form the nanofibre layer 3 thereon. In FIGS. 2 to 6, the nanofibre layer 3 is generated in each case on the bottom side of the fleece layer 2.

Furthermore, an adhesive 5 is applied onto a web-shaped cellulose layer 4 in the device 9. To this end, the cellulose layer 4 is unreeled from a cellulose layer reel 12, which quasi continuously provides the cellulose layer 4. In an adhesive application station 13, the adhesive 5 is applied onto a side of the cellulose layer 4. Purely exemplarily, this can take place by means of a transfer roll 14, which at the bottom dips into a tub 15 filled with adhesive and on its top side transfers the adhesive 5 onto the cellulose layer 4.

Practically, the cellulose layer 4 is impregnated prior to applying the adhesive 5. This is carried out in an impregnating station 16, which in a suitable manner provides the cellulose layer 4 with an impregnation 6 at least on the side provided with the adhesive 5. Applying the impregnation 6 can be carried out by dipping the cellulose layer 4 into an impregnating agent bath or by spraying on the impregnating agent.

In a connecting station 17, the fleece layer 2 and the cellulose layer 4 are brought together in such a manner that the adhesive 5 connects the cellulose layer 4 to the nanofibre layer 3. The connecting station 17 in this case is reproduced in a simplified form through two rolls 18, between which the individual layers 2, 3, 4 are guided through, so that the two rolls 18 roll off on each other by way of these layers 2, 3, 4. After the connecting station 17, a heating station 19 can be arranged, which ensures a hardening or drying of the adhesive 5.

Following this, the three-layered filter material 1 can be wound onto a filter material reel 20, which stores the web-shaped filter material 1 in a quasi continuous manner.

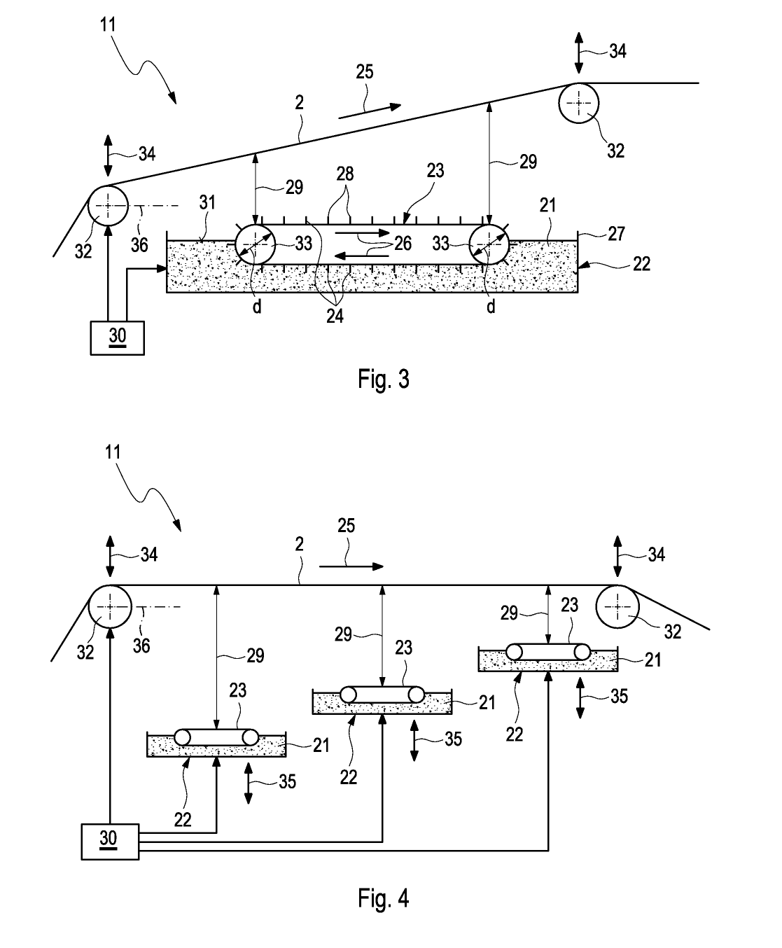

According to FIGS. 3 to 6, the coating station 11 can apply the nanofibres onto the fleece layer 2 electrostatically. To this end, the fleece layer 2 is guided past spaced from the liquid fibre material 21, which to this end is provided in at least one fibre dispensing device 22 of the coating station 11. In the embodiments shown in FIGS. 3, 5 and 6 respectively only one such fibre dispensing device 22 is provided.

In the embodiment shown in FIG. 4, three such fibre dispensing devices 22 are provided purely exemplarily.

Here, the respective fibre dispensing device 22 is realised with the help of a conveyor belt, which comprises a plurality of linear, rod-shaped or web-shaped dispensing elements 24. The dispensing elements 24 practically extend over the entire width of the respective fleece layer 2 and in the process extend transversely to a movement direction 25 of the fleece layer 2. The dispensing elements 24 in this case also extends transversely to a movement direction 26 of the conveyor belt 23. The conveyor belt 23 is arranged so that it dips into a tub 27 with its bottom side, in which tub the liquid fibre material 21 is stored. Because of this, the dispensing elements 24 are dipped into the liquid fibre material 21. On its top side, the conveyor belt 23 moves outside the liquid fibre material 21 and faces the fleece layer 2. The dispensing elements 24 practically define linear dispensing zones 28, which face the fleece layer 2 and which are spaced from the fleece layer 2. A corresponding spacing is drawn into FIGS. 3 to 6 and designated 29. The dispensing elements 24 can comprise a plurality of needle-shaped elevations (not shown) transversely to the movement direction 26 of the conveyor belt 23, as a result of which dot-shaped dispensing zones 28 can be realised.

The conveyor belt 23 is stretched out and driven by means of at least two rolls 33. In the example of FIG. 3, the rolls 33 have the same diameter d, so that the top side and bottom side of the conveyor belt 23, moving against each other, extend parallel to one another. In the example of FIG. 3, the rotation axes of the two rolls 33 are arranged in a common plane, which extends horizontally, Therefore, the top side and the bottom side of the conveyor belt 23 run horizontally here.

With the help of an ionising device 30, different electric potentials can be generated on the fleece layer 2 and on the fibre dispensing device 22, as a result of which an electrostatic charge is realised, which finally results in an ion current, which discharges molecules of the fibre material 21 from the dispensing zones 28, transports these in the direction of the fleece layer 2 and causes these to adhere to the fleece layer 2.

In the embodiment shown in FIG. 3, the previously mentioned spacing 29 between the fleece layer 2 and the dispensing zones 28 increases in the movement direction 25 of the fleece layer 2, namely continuously. In contrast with this, FIG. 4 shows an embodiment, in which the spacing 29 between the fleece layer 2 and the respective dispensing zone 28 decreases in the movement direction 25 of the fleece layer 2, namely in steps.

In FIG. 3, the fleece layer 2 is inclined relative to a horizontal and flat surface 31 of the liquid fibre material 21 in such a manner that said spacing 29 increases in the movement direction 25 of the fleece layer 2. In contrast with this, a plurality of fibre dispensing devices 22 are provided in the embodiment shown in FIG. 4, namely purely exemplarily three fibre dispensing devices 22. The fibre dispensing devices 22 are arranged one after the other in the movement direction 25 of the fleece layer 2 and differ from one another through different spatial heights, wherein different spacings 29 relative to the fleece layer 2 arise. Each fibre dispensing device 22 comprises a conveyor belt 23 of the type described with reference to FIG. 3, wherein these conveyor belts 23 however are represented simplified in FIG. 4; in particular, the individual dispensing elements 24 as well as their dispensing zones 28 are not shown. As can be seen, the spacing 29 decreases in the movement direction 25 of the fleece layer 2 from one fibre dispensing device 22 to the next.

In FIGS. 2 to 6, a plurality of deflection rollers 23 are additionally indicated, which deflect or align the fleece layer 2 or the cellulose layer 4 or the filter material 1. A front deflection roller 32, overtravelled first by the fleece layer 2, which deflection roller is illustrated on the left in FIGS. 3 to 6, and a rear deflection roller 32, overtravelled last by the fleece layer 2, which deflection roller is illustrated on the right in FIGS. 3 to 6, can be seen. In FIG. 3, the two deflection rollers 32 have different levels. The front deflection roller 32 is arranged deeper here than the rear deflection roller 32, so that the fleece layer 2 rises in its direction of movement.

In the example of FIG. 4, on the other hand, the two deflection rollers 32 have the same level, so that the fleece layer 2 extends horizontally between the deflection rollers 32.

Double arrows 34 in the case of the deflection rollers 32 indicate that optionally at least one of the deflection rollers 32 can be arranged adjustably with regard to its vertical spacing from the fibre dispensing device 22. Preferably, the vertical spacing measured perpendicularly to the horizontal, can be adjusted separately in the two deflection rollers 32. The vertical adjustability of at least one such deflection roller 32 allows an inclination to be adjusted, which the fleece layer 2 has between the deflection rollers 32 with respect to a horizontal plane 36, which is indicated in FIGS. 3 to 6 respectively by a dot-and-dash line. Through the vertical adjustability of at least one of the deflection rollers 32 also the spacings 29 between the dispensing zones 28 and the fleece layer 2 can be adjusted, in order to optimize the coating process.

In the embodiment shown in FIG. 4, optionally provision can also be made that at least one of the deflection rollers 32 is arranged vertically adjustably according to the double arrows 34. Additionally or alternatively, provision can be made that at least one of the fibre dispensing devices 22 is arranged vertically adjustably according to double arrows 35. In this way, also, the spacings 29 between the dispensing zones 28 and the fleece layer 2 can be adjusted.

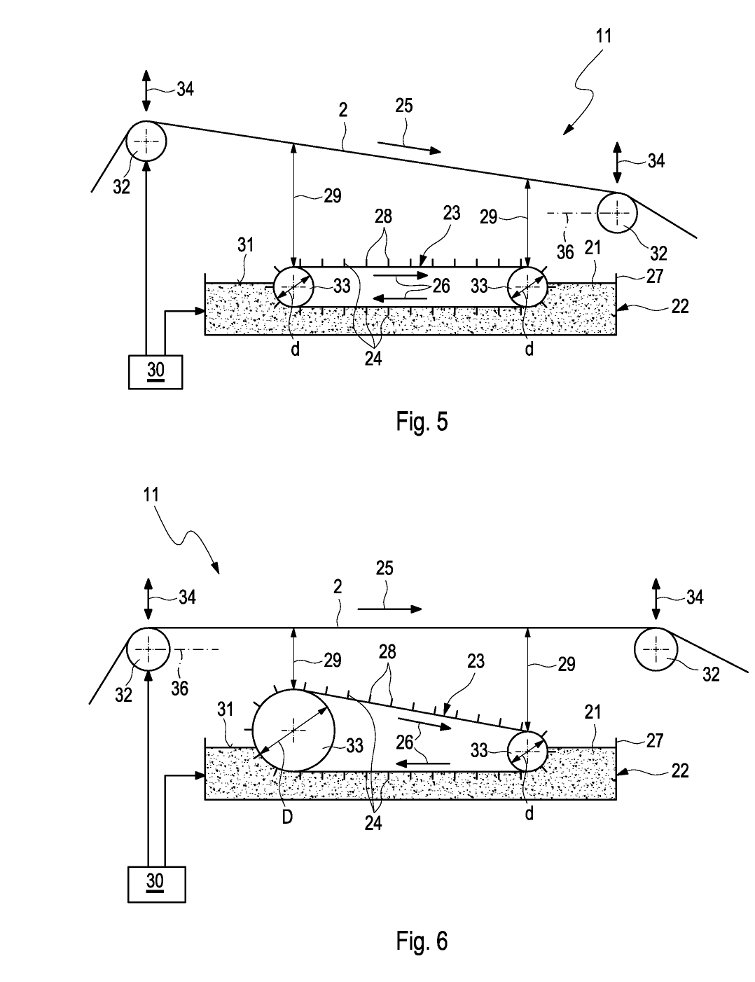

FIG. 5 shows an embodiment analogous to FIG. 3, in which, however, the levels of the deflection rollers 32 are inverted. Accordingly, here, the front deflection roller 32 is arranged higher than the rear deflection roller 32. Therefore, a slope results here for the fleece layer 2 in its movement direction 25. Consequently, the spacings 29 between the dispensing zones 28 and the fleece layer 2 decrease in the movement direction 25 thereof.

In the embodiment shown in FIG. 6, the two deflection rollers 32 are set again at identical heights. In this case, an increase of the spacings 29 between the dispensing zones 28 and the fleece layer 2 in the movement direction 25 thereof is achieved in that the rolls 33 of the conveyor belt 23 have different diameters d and D. In the example of FIG. 6, the diameter D of the left-hand roll 33 is distinctly greater than the diameter d of the right-hand roll 33. At the same time, the rolls 33 are arranged here so that the bottom side of the conveyor belt 23 within the fibre material 21 runs approximately horizontally. Consequently, the top side has a slope in the movement direction 25 of the fleece layer 2.

It is clear that the variants presented here in connection with FIGS. 3 to 6 for adjusting a varying spacing 29 between the dispensing zones 28 and the fleece layer 2 are also able to be combined with one another as desired.

1. A multi-layered, web-shaped filter material for a filter element, comprising:
a fleece layer,
a cellulose layer, and
a nanofibre layer arranged between the fleece layer and the cellulose layer, the cellulose layer coupled to the nanofibre layer via an adhesive,
wherein the nanofibre layer in a thickness direction has at least one of an increasing fibre thickness and an increasing fibre density,
wherein the cellulose layer has an impregnation at least on a side facing the nanofibre layer, the impregnation having a composition configured to at least impede the adhesive from penetrating the cellulose layer.

2. The filter material according to claim 1, wherein the at least one of the fibre thickness and the fibre density increases along the thickness direction at least one of continuously and in a transition step.

3. The filter material according to claim 1, wherein the at least one of the fibre thickness and the fibre density increases from the fleece layer to the cellulose layer.

4. The filter material according to claim 1, wherein
the nanofibre layer is a coating disposed on the fleece layer including a plurality of nanofibres.

5. (canceled)

6. The filter material according to claim 1, wherein at least one of:
the adhesive is a water based adhesive, and
the composition of the impregnation is at least one of a silicone based material and a silicone material.

7. The filter material according to claim 1, further comprising a filter element with at least one filter body which during operation of the filter element is subjected to a through-flow of at least one of a gas and a liquid.

8. The filter material according to claim 7, wherein the filter element is pleated.

9. The filter material according to claim 7, wherein the filter element is at least one of a ring filter element with a ring-shaped filter body and a plate filter element with plate-shaped filter body.

10. A method for producing a multi-layered, web-shaped filter material, comprising:
coating a web-shaped fleece layer with a nanofibre material on at least one side to directly form a nanofibre layer on the fleece layer,
adhering a web-shaped cellulose layer to the nanofibre layer via an adhesive, wherein the cellulose layer has an impregnation at least on a side facing the nanofibre layer, the impregnation having a composition configured to at least impede the adhesive from penetrating the cellulose layer, and
wherein coating the fleece layer with the nanofibre material results in the nanofibre layer having at least one of an increasing fibre thickness and an increasing fibre density in a thickness direction.

11. The method according to claim 10, wherein coating the fleece layer includes electrostatically applying the nanofibre material onto the fleece layer in a coating station, wherein a fibre dispensing section of the coating station has a spacing defined between a liquid fibre material and the fleece layer.

12. The method according to claim 11, wherein the spacing increases or decreases in a movement direction of the fleece layer.

13. The method according to claim 11, further comprising moving the fleece layer past a horizontal and flat surface of the liquid fibre material with an inclination.

14. The method according to claim 11, wherein a plurality of fibre dispensing sections are arranged in a movement direction of the fleece layer one after the other, and wherein a plurality of different spacings are defined between the liquid fibre material and the fleece layer.

15. The method according to claim 10, wherein at least one of:
the adhesive is applied onto the cellulose layer at least on the side having the impregnation, and
the cellulose layer and the fleece layer are joined at least in one region so that the adhesive connects the cellulose layer to the nanofibre layer.

16. The method according to claim 11, further comprising adjusting an inclination of the fleece layer with respect to a horizontal plane for adjusting the spacing.

17. A device for producing a filter material, comprising:
at least one fibre dispensing device including a conveyor belt having at least two rolls and a tub that is fellable with a liquid fibre material, wherein the conveyor belt at least on a bottom side dips into the tub,
at least two deflection rollers for guiding a fleece layer above the at least one fibre dispensing device and spaced apart from a top side of the conveyor belt, and
an ionising device for generating different electrical potentials on the fleece layer and on the at least one fibre dispensing device, such that the liquid fibre material is transported electrostatically from the conveyor belt to the fleece layer during operation,
wherein the at least two rolls having different diameters and are arranged so that the top side of the conveyor belt extends in an inclined manner with respect to a horizontal plane.

18. The device according to claim 17, wherein a spacing between the fleece layer and the top side of the conveyor belt varies in a direction of movement of the fleece layer.

19. The device according to claim 17, wherein at least one of the at least two deflection rollers is arranged vertically adjustable.

20. The device according to claim 17, wherein the at least one fibre dispensing device is arranged vertically adjustable.

21. (canceled)
